(19) United States
(12) Patent Application Publication
(10) Pub. No.: US 2009/0243170 A1
(43) Pub. Date: Oct. 1, 2009

(54) Coil spring genset vibration isolation system

(75) Inventors: Eric L. Nordstrom, Forest Lake, MN (US); Aaron C. Johnson, Champlin, MN (US); Peter G. Van de Walker, Ham Lake, MN (US)

Correspondence Address: KRIEG DEVAULT LLP, ONE INDIANA SQUARE, SUITE 2800, INDIANAPOLIS, IN, 46204-2079, US

(73) Assignee: Cummins Power Generation IP, Inc.

(21) Appl. No.: 12/080,206

(22) Filed: Apr. 1, 2008

(51) Int. Cl. F16F 13/00

(52) U.S. Cl. 267/140.11

(57) ABSTRACT

An electric power generation device includes a genset with an engine coupled to a generator and an enclosure that includes a base having a plurality of bosses protruding upwardly each a respective predetermined height from a surface of the base. A plurality of coil springs is positioned between an upper surface of each of the bosses and a respective mounting member of the genset. The bosses and the mounting members are positioned such that each respective coil spring is approximately equally loaded by the genset.

### BACKGROUND

The present application relates to electric power generation and the like and more particularly, but not exclusively, relates to a method, system and arrangement for reducing vibration associated therewith.

Recreational vehicles are an increasingly popular consumer item due at least in part to the many modern conveniences that may be installed in them. Often, the vehicle carries an electric power genset to electrically power such devices, including, for example, air conditioners, heaters, lighting, entertainment equipment, electronic devices, kitchen appliances and so forth. Frequently, operation of these gensets imparts an undesirable level of vibration in the vehicle cabin. Along with this vibration often comes undesired noise. Accordingly, there is a demand for further contributions in this area of technology.

### SUMMARY

One embodiment of the present application includes a unique technique to reduce vibration and/or noise cause by an electric power genset. Other embodiments include unique apparatus, devices, systems, and methods of genset mounting to reduce vibration and/or noise. Further embodiments, forms, objects, features, advantages, aspects, and benefits of the present application shall become apparent from the detailed description and figures included herewith.

### BRIEF DESCRIPTION OF THE DRAWINGS

The figures are not necessarily to scale, emphasis instead being placed upon illustrating the principles of the invention. Moreover, in the figures, like reference numerals designate corresponding parts throughout the different views.

FIG. 1 is a diagrammatic view of a vehicle carrying an electric power generation system.

FIG. 2 is a perspective, assembly view of an illustrative electric power generation system.

FIG. 3 is a perspective view of the components of the electric power generation system.

FIG. 3A is a detailed view of a portion of an isolation subsystem of the electric power generation system illustrated in FIGS. 1-3.

FIG. 4 is a perspective view of the components of the electric power generation system illustrated in FIGS. 1-3.

FIG. 4A is a detailed view of a portion of an isolation subsystem of the electric power generation system illustrated in FIG. 4.

FIG. 5 is a side plan view of the electric power generation system illustrating the vertical orientation of coil springs of the isolation subsystem.

FIG. 6 is a side plan view of the electric power generation system illustrating the vertical orientation of coils springs of the isolation subsystem that corresponds to the view line 6--6 in FIG. 5 and has a view plane perpendicular to the view plane of FIG. 5.

FIG. 7 is a top view of the electric power generation system illustrating the horizontal positioning of the coil springs of the isolation subsystem that corresponds to the view line 7--7 in FIG. 5 and has a view plane perpendicular to the view planes of FIG. 5 and FIG. 6.

FIG. 8 is a diagrammatic view illustrating one form of the geometric positioning of coil springs for the vibration isolation subsystem.

### DETAILED DESCRIPTION OF REPRESENTATIVE EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is intended, and any alteration or further modification of the illustrated device, and any further application of any principle of the invention as illustrated or described herein is contemplated as would normally occur to one skilled in the art to which the invention relates.

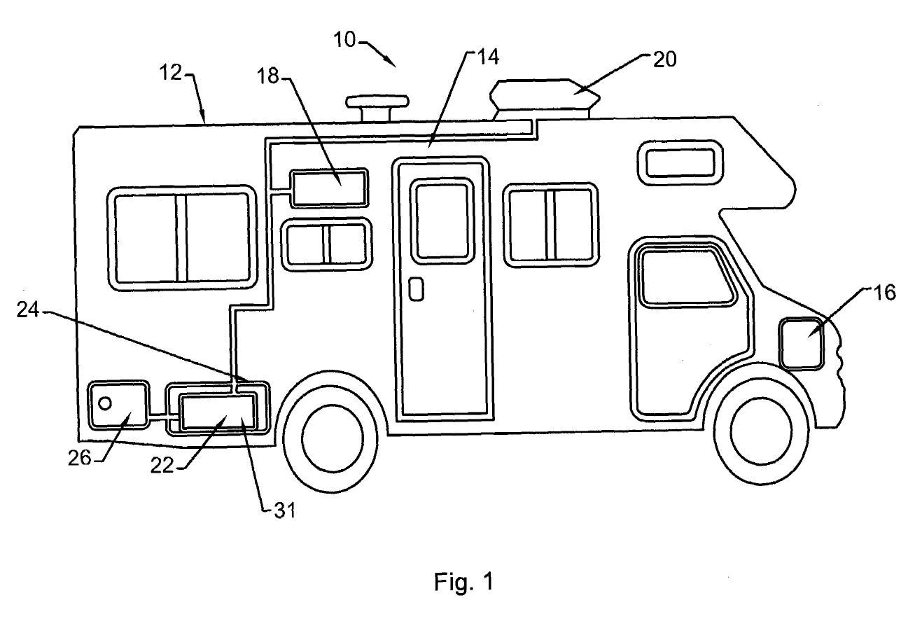

FIG. 1 illustrates vehicle 10 in the form of a motor coach 12. Motor coach 12 includes interior living space 14 and is propelled by coach engine 16. Coach engine 16 is typically of a reciprocating piston, internal combustion type. To complement living space 14, motor coach 12 carries various types of electrical equipment 18, such as an air conditioner 20. Equipment 18 may further include lighting, kitchen appliances, entertainment devices, and/or such different devices as would occur to those skilled in the art.

Motor coach 12 carries an electric power generation system or unit 22 to selectively provide electricity to equipment 18. Correspondingly, equipment 18 electrically loads the electric power generation system 22. In one form, electric power generation system 22 is located in a storage bay or other dedicated space 24 of motor coach 12. The storage bay 24 may include a vented door that provides access to the electric power generation system 22. In another form, system 22 is positioned between support rails of a chassis for coach 12.

Although illustrated as a motor coach 12, it should be appreciated by those skilled in the art that the electric power generation system 22 disclosed herein can be utilized in other types of vehicles such as pull along campers, marine craft, truck trailers, travel trailers, work vehicles, and larger recreational vehicles. In addition, the electric power generation system 22 can be utilized in commercial settings, residential settings, and as a portable unit.

As set forth in greater detail below, the electric power generation system 22 includes at least an internal combustion engine and a generator that constitute a “genset”, as designated by reference numeral 31, giving that term its commonly understood meaning. The genset 31 disclosed herein is mounted such that vibrations that are generated by operation of the genset 31 are substantially minimized or reduced so that people utilizing motor coach 12 do not feel transmitted vibrations from the electric power generation system 22.

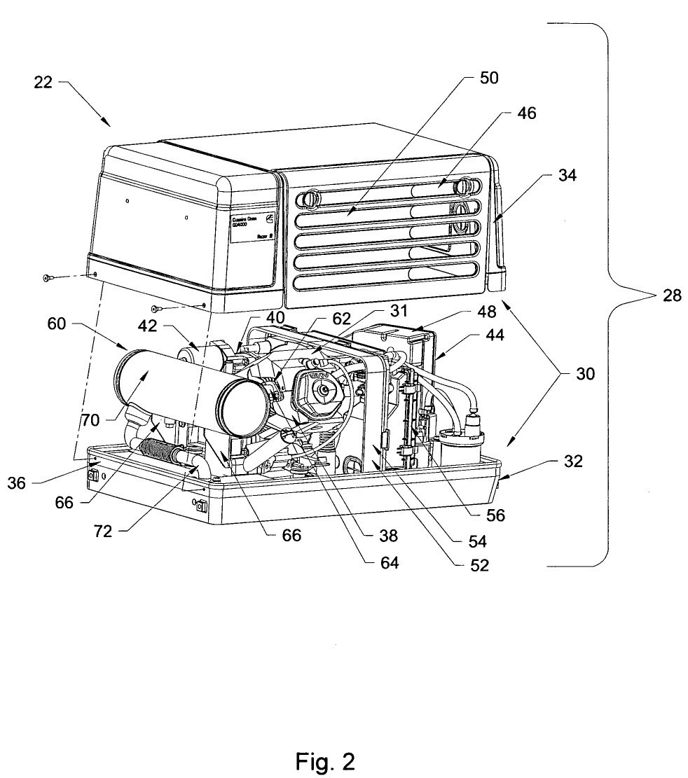

Referring to FIG. 2, a perspective view of a representative electric power generation system 22 is set forth. The electric power generation system 22 includes a two-piece enclosure 30 comprising a basepan or base 32 and a cover 34. Enclosure 30 houses a genset 31 as well as various other components of electric power generation system 22. Base 32 and cover 34 are illustrated as being generally rectangular in shape and cover 34 friction fits over an upper lip 36 of the base 32. In one example, base 32 is made or formed from diecast aluminum such as, for example, A380 diecast aluminum. However, in other embodiments, base 32 may be made of a different material suitable to reduce or eliminate transmitted vibrations from electric power generation system 22 with an isolation subsystem, as further described hereinafter. Collectively, enclosure 30 and genset 31 comprising a form of electric power generating device 28.

Genset 31 includes at least an internal combustion engine 38 coupled to a generator 40. A starter 42 is coupled to engine 38, which is controlled by an engine control unit 44 connected with starter 42, for starting engine 38. Referring collectively to FIGS. 1 and 2, engine 38 is in fluid communication with a fuel tank 26 of motor coach 12. Fuel tank 26 supplies fuel to engine 38 so that genset 31 can supply electricity to equipment 18. Engine 38 may comprise a liquid fueled diesel or gasoline internal combustion engine and/or a gaseous fueled type that uses a propane fuel, for example. In one arrangement, propane fueling of genset 31 uses the same fuel source as cooking equipment of coach 12.

In one form, generator 40 is operable to generate an alternating current (“AC”) output voltage signal and, if necessary, a direct current (“DC”) output voltage signal. When engine 38 is started, it drives or rotates generator 40 to cause generator 40 to produce AC electrical power. The portion of generator 40 that rotates or spins is a revolving field type of alternator, but other types of generators may be used. With appropriate power circuitry, generator 40 can be used to produce DC electrical power that may be used to provide DC power certain types of Dc equipment 18 and/or serve as a source of reserve electrical energy that can be converted to AC power for use with or instead of generator 40.

In one form, the AC output voltage is a standard 120 VAC output signal, but other types of output voltage signals may also be generated. In one example, engine 38 has a horsepower rating between 7.0-27 HP and may include anywhere from 1-3 cylinders. Further, in one form generator 40 is capable of generating output power ranging from 2,800-12,500 Watts. The horsepower rating of engine 38 and power rating of generator 40 may vary from the illustrative examples set forth above in alternative embodiments of the present invention. For the purpose of the present invention, it should be noted that engine 38 provides mechanical energy to generator 40, which in turn, converts the mechanical energy generated by engine 38 into electrical power used by equipment 18 associated with motor coach 12.

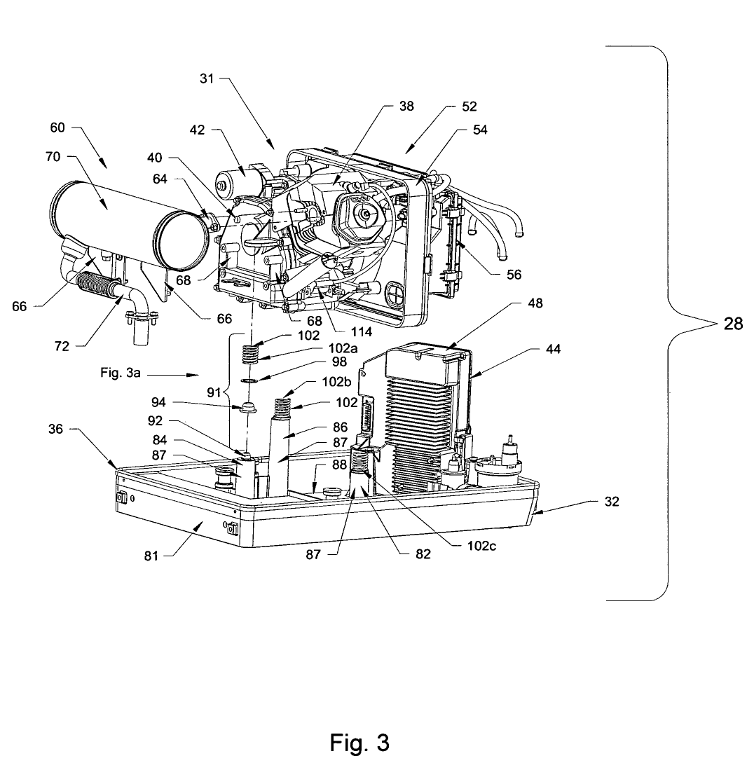

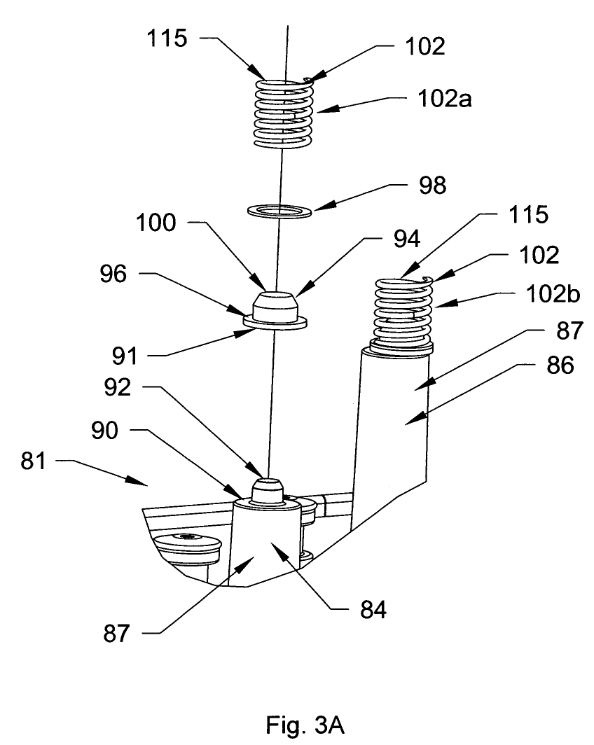

Cover 34 includes a panel opening 46 for receipt of a large service panel 48 in the front of electric power generation system 22. Cover 34 also includes an air inlet 50 that allows ambient air to enter enclosure 30. As illustrated, genset 31 also includes a cooling system 52 connected with engine 38. Cooling system 52 includes a cooling impeller assembly 54 and associated housing assembly 56. Cooling impeller assembly 54 is powered by engine 38 to help cool engine 38. Electric power generation system 22 includes an exhaust system 60 connected with an exhaust manifold 62 of engine 38. Exhaust system 60 includes an exhaust gas inlet pipe 64 connected with exhaust manifold 62 of engine 38. In addition, exhaust system 60 includes a bracket assembly 66 that connects the exhaust system 60 to a plurality of connection members 68 (See FIG. 3) of generator 40. Connection members 68 may also be located on engine 38 or other respective components of genset 31.

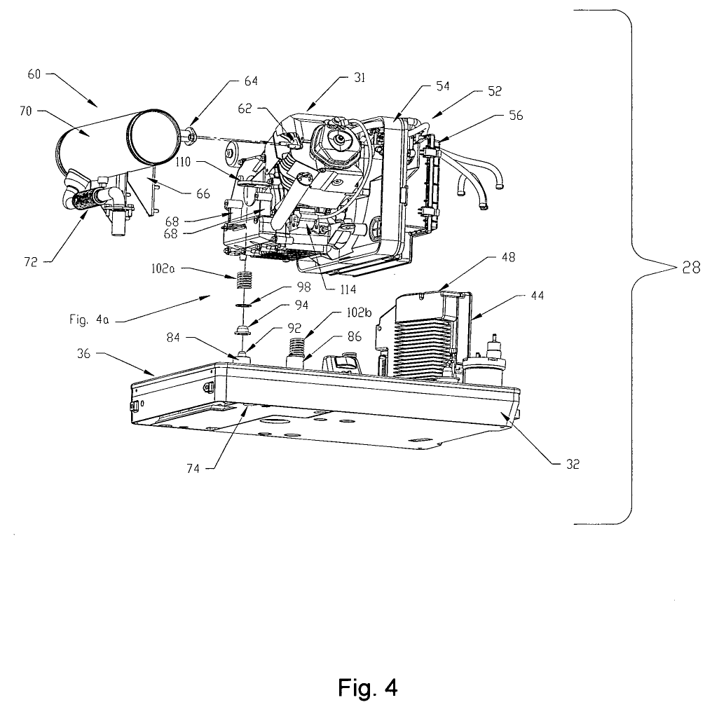

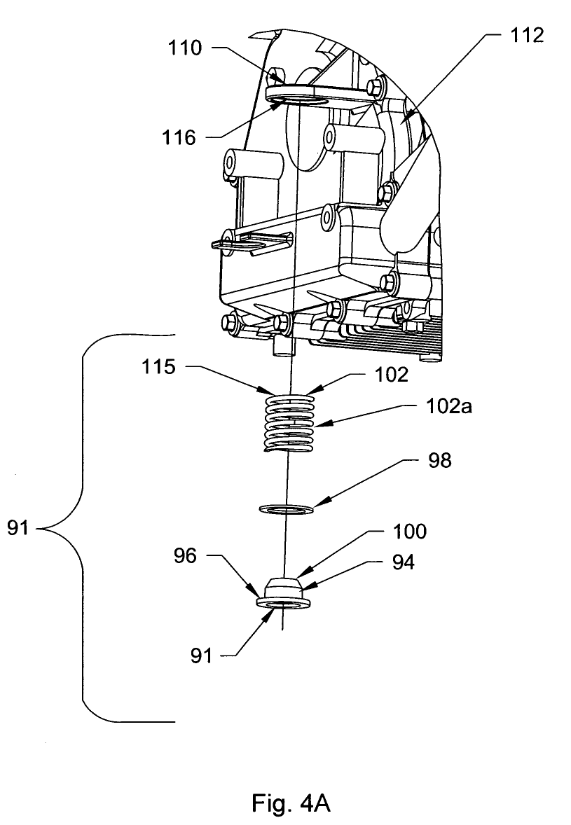

Exhaust gas inlet pipe 64 is connected with a muffler 70 of exhaust system 60. Muffler 70 silences operation of engine 38 and may be used to provide emissions treatment of exhaust gas exiting engine 38 as desired. An exhaust gas outlet pipe 72 is connected with an output of muffler 70. Exhaust gas outlet pipe 72 protrudes through an aperture 74 (See FIG. 4) in base 32 and may be connected with an exhaust pipe (not shown) of motor coach 12.

Referring collectively to FIGS. 3 and 3A, electric power generation system 22 includes a vibration isolation subsystem 80 in the form of a support mechanism 81. In one form, vibration isolation subsystem 80 supports the mass of engine 38, generator 40, cooling system 52, and exhaust system 60. In other forms, vibration isolation subsystem 80 supports at least engine 38 and generator 40. Vibration isolation subsystem 80 substantially reduces or eliminates the transmitted vibration of genset 31 during operation. Computer analysis of vibration isolation subsystem 80 reveals that the transmitted vibratory energy of genset 31 is reduced over 100 times from prior elastomer based isolation systems.

Vibration isolation subsystem 80 includes at least a first support tower or boss 82, a second support tower or boss 84 and a third support tower or boss 86, but may include additional support towers in alternative forms. These bosses 82, 84, and 86 are alternatively designated support members or pillars 87. Support towers 82, 84, and 86 protrude upwardly from a lower surface 88 of base 32. As set forth in greater detail below, support towers 82, 84, and 86 protrude upwardly at predetermined heights in order to properly support the mass of genset 31 such that genset 31 is properly supported to reduce transmitted vibrations of genset 31 during operation. The support towers 82, 84, and 86 are geometrically positioned, both vertically and horizontally, such that the mass of genset 31 is supported in a manner that reduces or eliminates the transmitted vibratory energy generated by operation of genset 31. Although three support towers 82, 84, and 86 are illustrated in this form, it should be appreciated that in other forms more than three support towers and corresponding elements described below may be used.

Support towers 82, 84, and 86 are illustrated has having a generally cylindrical shape in FIGS. 3 and 3A. Other shapes such as rectangular-shaped, and so forth are envisioned. An upper surface 90 of each respective support tower 82, 84, and 86 includes a dome-shaped retaining member 92 that protrudes upwardly a predetermined distance from upper surface 90 to receive a respective vibration isolation device 91 (partially shown in FIGS. 3 and 3A). For the depicted embodiment, device 91 includes spring dampening sleeve 94 positioned over each retaining member 92 of the support towers 82, 84, and 86. Spring dampening sleeve 94 includes a lower surface that rests on upper surface 90 of support towers 82, 84, and 86. In one form, spring dampening sleeve 94 comprises an elastomer-based sleeve, such as a Buna-N based durometer elastomer, but could be manufactured from other suitable material as well. Spring dampening sleeve 94 has been found to reduce high frequency noise that is generated during operation of genset 31.

In addition to sleeve 94, vibration isolation devices 91 also each include a flat washer 98 and three springs 102 (more specifically designated springs 102a, 102b, and 102c). An outside upper rim surface 96 of spring dampening sleeve 94 is configured to receive a flat washer 98 that fits over a dome-shaped portion 100 of spring dampening sleeve 94. Flat washer 98 fits over dome-shaped portion 100 of spring dampening sleeve 94 and rests on outside upper rim 96. Flat washer 96 protects spring dampening sleeves 94 from damage that may be caused by vibration of a plurality of coil springs 102a-c that are positioned on an upper surface of each respective flat washer 98. As set forth in detail below, coil springs 102a-c support the weight or mass of genset 31 on support towers 82, 84, and 86. Coil springs 102a-c may be manufactured using several materials, such as coated chrome silicon or 17-7 stainless steel, for example.

Referring to FIGS. 4 and 4A, genset 31 includes a plurality of spring retention members 110 that extend off of or are otherwise connected to genset 31. Spring retention members 110 may be connected to a gearcase 112 of generator 40, an engine block 114 of engine 38, or at a variety of other predetermined locations of genet 31. Although not illustrated, in one form, genset 31 includes three spring retention members 110 that are located on various parts of genset 31. Spring retention members 110 are oriented or positioned at predetermined locations on genset 31 such that an upper end 115 of coil springs 102a-c fit within a pocket 116 of spring retention members 110. Spring retention members 110 are positioned on genset 31 such that pockets 116 line-up with each respective support tower 82, 84, and 86. Although spring retention member 110 is illustrated as a cast part of genset 31, it should be appreciated that in other forms spring retention member 110 may comprise a bolt-on bracket member that is connected to genset 31.

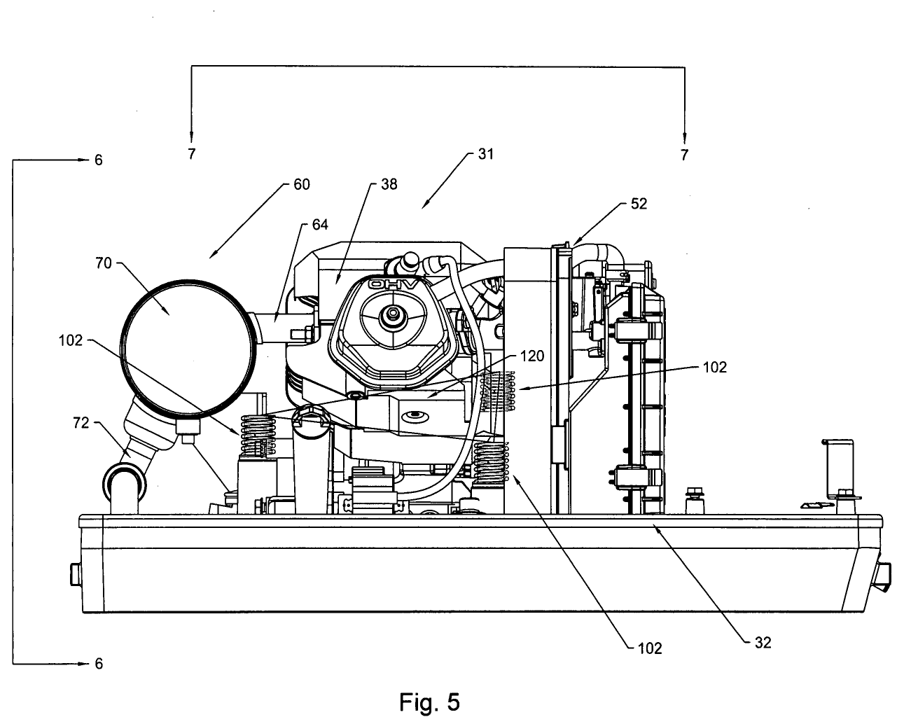

Referring to FIG. 5, in one form, genset 31 comprises an engine 38, generator 40 (not visible), cooling system 52, and exhaust system 60. All of these respective components of genset 31 have a predetermined mass or weight when assembled or connected to one another or otherwise assembled. Genset 31 is positioned on base 32 such that genset 31 rests on top of isolation subsystem 80. Genset 31 rests on top of coil springs 102a-c and gravity forces genset 31 to remain on top of isolation subsystem 80. In particular, genset 31 is positioned on top of coil springs 102a-c such that upper portion 115 of each respective coil spring 102a-c fits within a respective spring pocket 116 of each spring retention member 110 associated with genset 31. See FIG. 3. Although upper portion 115 of coil spring 102a is illustrated as fitting within an inside diameter of spring pocket 116, in another representative form, spring retention member 110 may include a retaining member 92 (See FIG. 3A) that fits within an inside diameter of coil spring 102a. The height of springs 102a-c are designed such that changes in the height of two respective coil springs force resultant changes in the height of the other coil spring to keep the coil springs 102a-c in-plane with the center of gravity of genset 31.

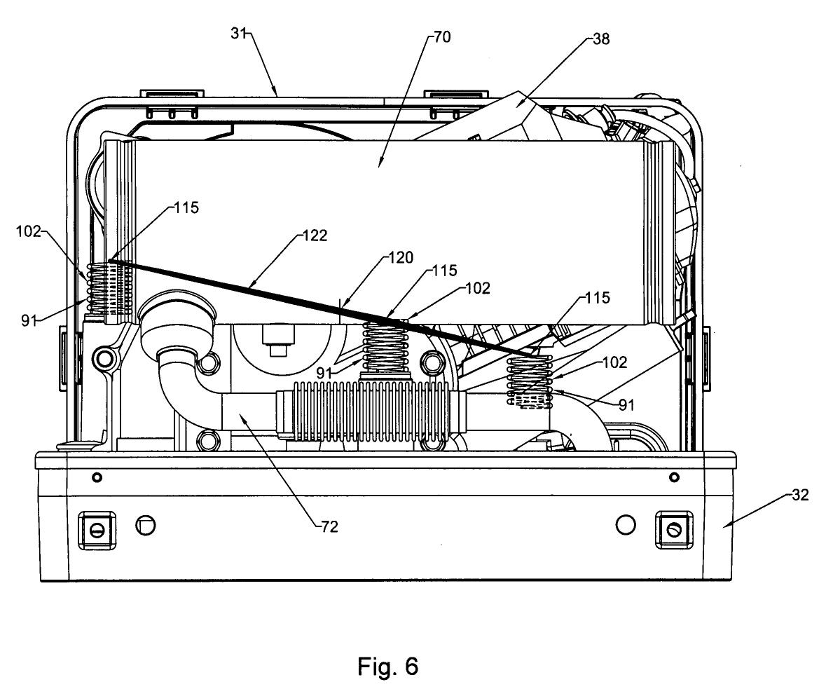

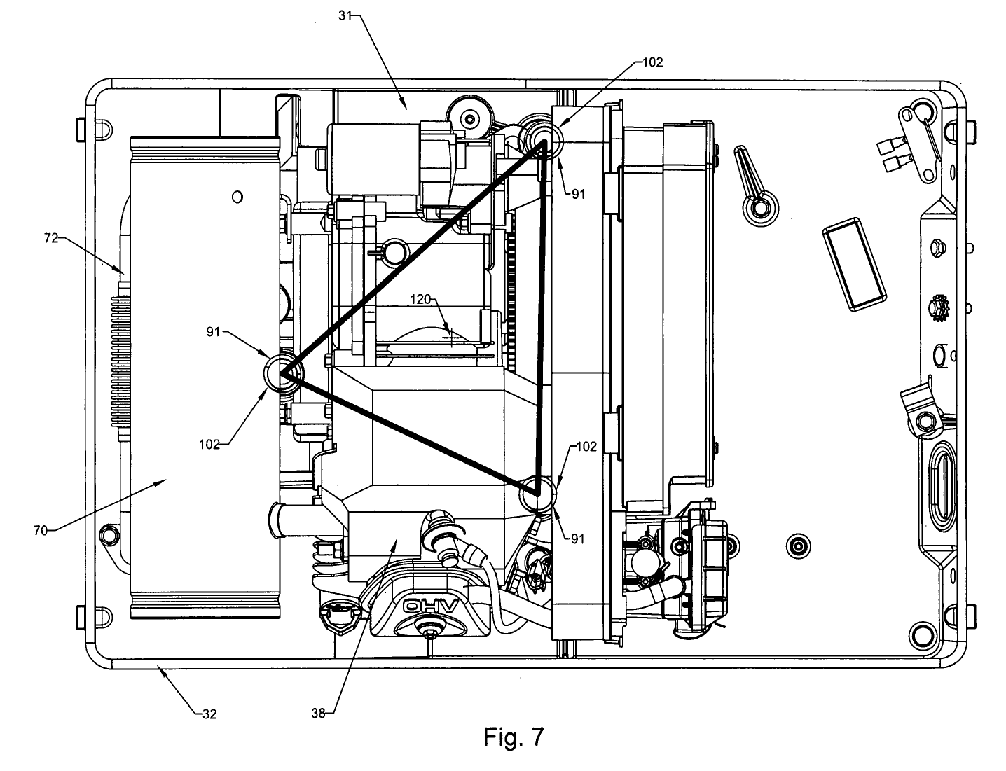

As illustrated in FIGS. 5-7, which more clearly illustrates the orientation of coil springs 102a-c, genset 31 has a known center of gravity 120 which is represented as a cross-hair in FIGS. 5-7. The center of gravity 120 represents the average location of the weight of genset 31. As previously set forth, when installed on top of isolation subsystem 80, genset 31 rests on top of upper surface 115 of coil springs 102a-c. In addition, the location of support towers 82, 84, and 86 in base 32, and hence coil springs 102a-c, is such that a reference plane 122 (See FIG. 6) through upper portion 115 of coil springs 102a-c coincides with the center of gravity 120 of the mass of genset 31 as it rests on springs 102. It should be appreciated that the exact position of genset 31 may vary with movement and force applied such as when one or more of springs 102a-c are dynamically compressed. Accordingly, the location of intersection of reference plane 122 through one or more of springs 102a-c, may vary during operation while still passing through the center of gravity of genset 31. Alternatively or additionally, the point of spring intersection by reference plane 102 may vary from one apparatus to the next, while still remaining coincident with the center of gravity 120 of genset 31. In further embodiments, it should be appreciated that the reference plane intersection through center of gravity 120 may not always (or ever) be exactly coincident, but instead is approximate—being within an acceptable tolerance range. In one preferred form, this tolerance range is plus or minus ten percent (±10%) of the distance spanned by any of the springs 102a-c between the respective support tower 82, 84, or 86 and the genset (or other vibration isolator) while the genset is at rest thereon. In a more preferred form, this tolerance range is plus or minus five percent (±5%). In an even more preferred form, this tolerance range is plus or minus one percent (±1%). Nonetheless, it should be

In other representative forms, reference plane 122 can pass through any portion of coil springs 102a-c. In one nonlimiting form, support towers 82, 84, and 86 are positioned as high as possible so that coil springs 102a-c can be located as high as possible while still approximately lying in reference plane 122.

In another representative form, support towers 82, 84, and 86, coil springs 102a-c and spring retention members 110 are specially oriented in relation to genset 31 such that the mass or weight of genset 31 is approximately equally supported by each respective coil spring 102a-c. In one nonlimiting form, the mechanical load distributed among isolation devices 91 is the same within a tolerance of plus or minus 10 percent (±10%). In one form, coil springs 102a-c are relatively soft coil springs, equally loaded with a stiffness ratio (axially and laterally) of 1:1. Coil springs 102a-c, in alternative forms, may include dead coils to allow for softer coil springs. In addition, coil springs 102a-c may comprise hourglass shaped coil springs such that in a surge condition, the upper and lower coils of the springs would be dead and stop the surge. The vertical heights of coil springs 102a-c may be increased or decreased to allow for variations in geometry limitations.

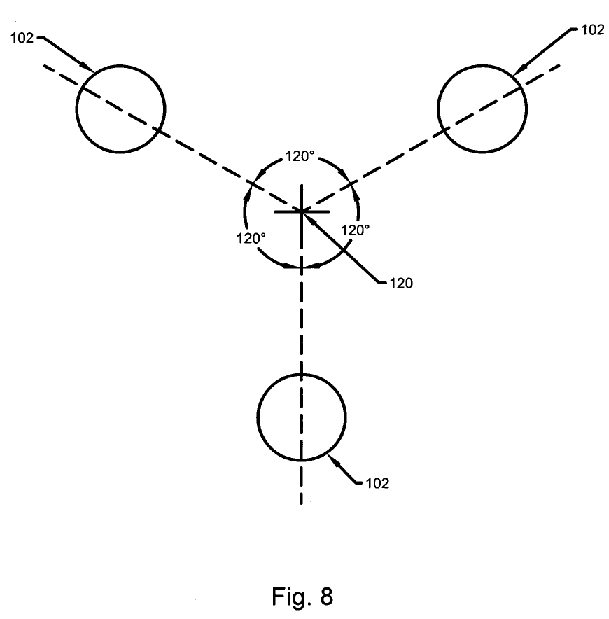

Referring to FIG. 8, which illustrates a top view of coil springs 102a-c in relation to the center of gravity 120 of genset 31, in one form three coil springs 102a-c are used in isolation subsystem 80. In this illustrative example, the three coil springs 102a-c are spaced apart from one another by 120 degrees (120°) and approximately at the same vertical level as the center of gravity 120. In addition, coil springs 102a-c are located an equal lineal distance from the center of gravity 120 of the genset 31. Although not illustrated, in other examples four coil springs may be used that are spaced 900 apart an equal distance from the center of gravity 120. Yet in another example, five or more coil springs may be used to support the mass of genset 31.

Referring back to FIGS. 5-7, in other forms, coil springs 102a-c may be used that are not positioned equally spaced apart from the center of gravity 120. Further, coil springs 102a-c also may not be spaced apart 1200 from the center of gravity 120 of the genset 31 or at the same vertical height. As illustrated in FIG. 6, in this form, the tops or upper surface 115 of coil springs 102a-c are in-plane with the center of gravity 120 of the mass of the genset 31 as it rests on the springs. In addition, each of the coil springs 102a-c are arranged in relation to genset 31 so that each coil spring 102a-c is approximately equally loaded, both axially and vertically, by the mass of genset 31. For example, in the example illustrated in FIGS. 5-7, coil spring 102a has a vertical load of 26.9 pounds and an axial load of 26.9 pounds, coil spring 102b has a vertical load of 27.0 pounds and an axial load of 27.0 pounds, and coil spring 102c has a vertical load of 26.9 pounds and an axial load of 26.9 pounds.

Referring to FIG. 3, as set forth above vibration isolation subsystem 80 includes support members 82, 84, and 86 that protrude upwardly from lower surface 88 of base 32. Support members 82, 84, and 86 are three-dimensionally oriented, both vertically and horizontally, in base 32 such that an upper surface 115 of coil springs 102a-c lie in plane with the center of gravity 120 of genset 31. In addition, the three-dimensional orientation of support members 82, 84, and 86 is such that the mass or weight of genset 31 is approximately equally distributed on coil springs 102a-c.

Many embodiments of the present application are envisioned. In one form, a system is disclosed that includes an electrical power generation unit having an internal combustion engine coupled to a generator. The system also includes a base having a first support tower, a second support tower, and a third support tower. Each support tower protrudes upwardly from the base a predetermined distance. A coil spring is positioned between an upper surface of each support tower and a respective lower surface of the electrical power generation unit. Each said support tower is oriented on the base such that each coil spring is equally loaded by the weight of the electrical power generation unit.

In another form, a system is disclosed that includes an electric power generating device including an internal combustion engine coupled to an electric power generator, the electric power generating device including three mounting sites; a support mechanism to engage the electric power generating device and bear mechanical load thereof, the support mechanism including: a base including three support pillars, the support pillars each extending away from the base and each providing a corresponding mount at a predetermined distance from the base; and three vibration isolation devices each positioned between a respective one of the three mounting sites and the corresponding mount of a respective one of the support pillars, where a reference plane through each of the vibration isolation devices approximately intersects a center of gravity of the electric power generating device.

In yet another form, an apparatus is disclosed that includes a genset for generating electric power. The apparatus also includes a base including a plurality of bosses that protrude upwardly each a respective predetermined height from a surface of the base. A plurality of coil springs are positioned between an upper surface of each of the bosses and a respective mounting member of the genset, wherein the bosses and the mounting members are positioned in relation to the genset such that each respective coil spring is approximately equally loaded by the weight of the electric power generation unit.

In still another form, a method is disclosed that includes: providing a genset; providing a base having a plurality of support members protruding upwardly from a lower portion of the base; placing a coil spring on top of each the support member; and positioning the genset on top of the coil springs, wherein the support members are positioned in the base such that each coil spring is approximately equally loaded by the genset.

Yet another form is directed to a system comprising: means for providing a genset; providing a base having a plurality of support members protruding upwardly from a lower portion of the base; means for placing a coil spring on top of each the support member; and means for positioning the genset on top of the coil springs, wherein the support members are positioned in the base such that each coil spring is approximately equally loaded by the genset.

In another form, a system is disclosed comprising a genset; a base; a vibration isolation subsystem including a plurality of support members each three-dimensionally oriented about a center of gravity of the genset in the base. Each of the support members includes a coil spring positioned between an upper surface of the support member and a spring retention member of the genset. The three-dimensional orientation of the support members in the base is such that each coil spring is approximately equally loaded by the genset.

A further form includes: an electric power generating device including an internal combustion engine coupled to an electric power generator, the electric power generating device including at least three mounting sites; and a support mechanism to engage the electric power generating device and bear mechanical load thereof. The support mechanism includes: a base including three support pillars, the support pillars each extending away from the base and each providing a corresponding mount at a predetermined distance from the base; and three vibration isolation devices each positioned between a respective one of the three mounting sites and the corresponding mount of a respective one of the support pillars, the vibration isolation devices each bearing one third of the mechanical load of the electric power generating device with a tolerance of plus or minus 10% and suspending at least a portion of the electric power generating device between the support pillars above the base.

Still a further form comprises: an electric power generating device including at least a portion of an internal combustion engine and an electric power generator mechanically coupled to the internal combustion engine, the electric power generating device including three mounting sites and a support mechanism to engage the electric power generating device and bear mechanical load thereof. The support mechanism includes: a base including three support members, the support members each extending from the base and each providing a corresponding mount; and three vibration isolation devices each positioned between a respective one of the three mounting sites and the corresponding mount of a respective one of the support members, the vibration isolation devices each bearing a respective portion of the mechanical load of the electric power generating device, the support mechanism being configured to define a plane coincident with a center of gravity of the electric power generating device that passes between the respective one of the mounting sites and the corresponding mount of each of the support members.

Another form comprises: providing a genset including an internal combustion engine coupled to an electric power generator that has three mounting sites; supporting the mechanical load of the genset with a support mechanism that includes a base and three support pillars each extending away from the base, the pillars each providing a corresponding mount at a predetermined distance from the base; reducing vibration with three vibration isolation devices each positioned between a respective one of the three mounting sites and the corresponding mount of a respective one of the support pillars; and positioning the three vibration isolation devices such that changes in the position of two of the vibration isolation devices causes a resultant change in another of the vibration isolation devices to keep the vibration isolation devices approximately in-plane with a center of gravity of the genset.

In yet another form, a method is disclosed that includes: providing a genset; providing a base having a plurality of support members protruding upwardly from a lower portion of said base; placing a coil spring on top of each said support member; and positioning said genset on top of said coil springs, where said coil springs are vertically oriented in relation to said base such that a respective portion of each said coil spring lies in a plane coincident with a center of gravity of the genset.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary. While the invention has been illustrated and described in detail in the drawings and foregoing description, the same is to be considered as illustrative and not restrictive in character, it being understood that only the selected embodiments have been shown and described and that all changes, modifications and equivalents that come within the spirit of the invention as defined herein or by any of the following claims are desired to be protected.

What is claimed is:

1. A system, comprising:
an electric power generating device including an internal combustion engine coupled to an electric power generator, the electric power generating device including three mounting sites;
a support mechanism to engage the electric power generating device and bear mechanical load thereof, the support mechanism including:
a base including three support pillars, the support pillars each extending away from the base and each providing a corresponding mount at a predetermined distance from the base; and
three vibration isolation devices each positioned between a respective one of the three mounting sites and the corresponding mount of a respective one of the support pillars, where a reference plane through each of the vibration isolation devices approximately intersects a center of gravity of the electric power generating device.

2. The system of claim 1, wherein the vibration isolation devices each bear about one third of the mechanical load of the electric power generating device with a tolerance of plus or minus 10% and suspend at least a portion of the electric power generating device between the support pillars above the base.

3. The system of claim 1, where the support pillars are positioned relative to each other to place each of the vibration isolation devices approximately an equal distance from a center of gravity of the electric power generating device.

4. The system of claim 3, where the support pillars each intersect a different one of three radial reference lines having the center of gravity as a common origin, each one of the three radial reference lines being spaced apart from the others by approximately 120 degrees.

5. The system of claim 1, wherein the vibration isolation devices each include a respective coil spring.

6. The system of claim 5, further comprising a respective dampening sleeve positioned between the corresponding mount of each of the support pillars and a lower portion of the respective coil spring, and a washer positioned between the respective dampening sleeve and the respective coil spring for each of the support pillars.

7. The system of claim 6, where said lower surface of said electrical power electric power generating device includes three spring pockets each positioned in alignment with the corresponding mount, where an upper portion of the respective coil spring of each of the vibration isolation devices engages a corresponding one of the spring pockets.

8. A method, comprising:
providing a genset;
providing a base having a plurality of support members protruding upwardly from a lower portion of said base;
placing a vibration isolator on top of a respective one of said support members;
installing said genset to rest on top of said vibration isolators; and
wherein said installing of the genset positions each of the vibration isolators to intersect a reference plane, the reference plane being coincident with a center of gravity of the genset resting on said vibration isolators within a tolerance range.

9. The method of claim 8, wherein the tolerance range is plus or minus ten percent of the shortest distance spanned by a respective one of the vibration isolators between the respective one of the support members and the genset at rest thereon.

10. The method of claim 8, wherein the tolerance range is plus or minus five percent of the shortest distance spanned by a respective one of the vibration isolators between the respective one of the support members and the genset at rest thereon.

11. The method of claim 8, wherein the tolerance range is plus or minus one percent of the shortest distance spanned by a respective one of the vibration isolators between the respective one of the support members and the genset at rest thereon.

12. The method of claim 8, wherein the vibration isolators are each include a corresponding coil spring.

13. The method of claim 12, which includes providing a respective dampening sleeve between each of the support members and a lower portion of the corresponding coil spring of each of the vibration isolators.

14. The method of claim 12, which includes bearing about one third of the mechanical load of the genset with a tolerance of plus or minus ten percent on each of the vibration isolators and suspending at least a portion of the electric power generating device between the support members above the base.

15. A method, comprising:
providing a genset;
providing a base having a plurality of support members protruding upwardly from a lower portion of said base a predetermined distance;
placing a coil spring on top of each said support member; and
positioning said genset on top of said coil springs, where said support members are oriented in said base such that each said coil spring is approximately equally loaded by the weight of said genset.

16. The method of claim 15, further comprising placing a dampening sleeve between an upper surface of said support member and a lower surface of said coil spring.

17. The method of claim 16, further comprising placing a washer between said dampening sleeve and said lower surface of said coil spring.

18. The method of claim 15, where said step of positioning said genset on top of said coil springs includes positioning an upper surface of each said coil spring in a spring retention pocket of said genset.

19. The method of claim 15, where an upper surface of said coil springs lies in a common plane with a center of gravity of said genset.

20. A system, comprising:
an electric power generating device including at least a portion of an internal combustion engine and an electric power generator mechanically coupled to the internal combustion engine, the electric power generating device including three mounting sites;
a support mechanism to engage the electric power generating device and bear mechanical load thereof, the support mechanism including:
a base including three support members, the support members each extending from the base and each providing a corresponding mount; and
three vibration isolation devices each positioned between a respective one of the three mounting sites and the corresponding mount of a respective one of the support members, the vibration isolation devices each bearing a respective portion of the mechanical load of the electric power generating device, the support mechanism being configured to define a plane coincident with a center of gravity of the electric power generating device that passes between the respective one of the mounting sites and the corresponding mount of each of the support members.

21. The system of claim 20, where the respective portion is one third of the mechanical load of the electric power generating device with a tolerance of plus or minus 10%.

22. The system of claim 20, where the support pillars are positioned relative to each other to place each of the vibration isolation devices approximately an equal distance from a center of gravity of the electric power generating device.

23. The system of claim 20, where the vibration isolation devices each include a respective coil spring.

24. The system of claim 23, further comprising a respective dampening sleeve positioned between the corresponding mount of each of the support pillars and a lower portion of the respective coil spring, and a washer positioned between the respective dampening sleeve and the respective coil spring for each of the support pillars.

25. The system of claim 24, where said lower surface of said electrical power electric power generating device includes three spring pockets each positioned in alignment with the corresponding mount, where an upper portion of the respective coil spring of each of the vibration isolation devices engages a corresponding one of the spring pockets.
